(19) United States
(12) Patent Application Publication
(10) Pub. No.: US 2022/0240491 A1
(43) Pub. Date: Aug. 4, 2022

(54) AUTOMATIC AQUARIUM FEEDER

(71) Applicant: ERIK HUNTER, SANTEE, CA (US)

(72) Inventor: ERIK HUNTER, SANTEE, CA (US)

(21) Appl. No.: 17/163,094

(22) Filed: Jan. 29, 2021

(51) Int. Cl. A01K 61/85; F25D 19/00

(52) U.S. Cl. CPC A01K 61/85; F25D 19/00

(57) ABSTRACT

An automated aquarium frozen fish food feeder has a housing containing a cooling device and a dispensing device. Frozen fish food cubes dispensed into a basket melt before being accessible to fish. Melted fish food exits through openings in the basket of a size that prevent dispersal of the frozen cubes. The device structure minimizes heat exchange with ambient air. A carousel rotates to place a food container periodically in registration with a food outlet. A mechanism opens the bottom surface of the food container and dispenses food through the outlet aperture. The carousel surface is treated with friction-free coating. The carousel is removable from the carousel chamber for cleaning or filling. Different carousels are provided each dedicated to a particular size of frozen food cubes. The carousel chamber is included in a drawer below the cooling device for easy access for cleaning and for inserting selected carousels.

### FIELD

The present subject matter relates to an automated frozen fish feeding system to feed fish in aquariums.

### BACKGROUND

Providing frozen food to fish in an aquarium has many advantages over feeding flake or pellet foods. Frozen fish food provides important vitamins not available from flake or pellet foods. It can also bore the fish into not eating. Experience shows that fish eating frozen food are more energetic and more colorful. Fish have very delicate stomachs. Many fish experience digestive problems by consuming only flake or pellet foods. Problems that fish experience include constipation.

Frozen fish food comes in a form totally different from flake or pellet foods. The foods are commonly formed in cubes and stored in blister packs. Another common form of frozen fish is a solid block. Automatic feeders must be able to keep the food frozen, dispense the food, and be sure that the food is delivered so that fish do not swallow ice.

Prior apparatus that provides automated frozen fish food feedings have included cumbersome structures. These earlier apparatus achieved their function by providing a composite of a refrigerator, hot air blower, a large clockwork mechanism driving a rotated food dispenser, and complex plumbing. More recent apparatus is better developed but still has significant shortcomings.

U.S. Pat. No. 5,709,166 discloses an automatic fish feeder which is refrigerated and does not comprise a freezer. The feeder is contained within a cylinder. A heat sink shroud and a fan are mounted on a cover of the cylinder. A food tray has compartments which are loaded with food. The food tray is rotated. When a predetermined compartment reaches a feeding location, a trap door is opened by a pin. Since this feeder is only refrigerated not frozen, stored food may be simply dropped out of the food tray. This construction is not suitable for frozen food feeding because it does not account for the need to defrost food before it is accessible to fish.

U.S. Pat. No. 6,009,835 discloses an automatic feeder having a wheel with food compartments that each periodically come into registration with a food dispensing location. This apparatus uses a piston to force food out and open a compartment at the same time. This arrangement requires compression of the food against the piston and against a trapdoor which closes the compartment. It also requires mechanisms to operate the piston and to remove the piston to a sufficient height so that rotation of compartments is not obstructed. This operation requires more frequent cleaning to compressive forces applied by the piston. Also the frozen food is dispensed directly into the water. Fish may ingest ice, which may make them sick.

U.S. Pat. No. 10,405,525 discloses a frozen food aquarium feeder having upper and lower coaxial cylinders. The upper cylinder rotates with respect to the lower cylinder. The lower cylinder must be disposed with its upper surface at a water line. The upper cylinder must be disposed outside of water. Since the water line is subject to change, as between fillings, the feeder must be vertically movable with respect to the aquarium wall. Movability is provided by having magnets on the feeder and on the outside of the aquarium to hold the feeder in place. This support is less reliable than fixed fastening means. Extra care must be used in repositioning the feeder when the water line level changes. A user must also exercise care in maintaining the height of the feeder when filling or adjusting the feeder.

United States Patent Application Publication No. 20150208619 discloses a temperature regulated aquarium feeder. A temperature control storage container for housing temperature sensitive foods is heated or cooled. Individual compartments for food servings are not provided. Pumps or metered gravity feed must be used to dispense food. A cartridge for storing successive days worth of feedings is not provided.

United States Patent Application Publication No. 20090255474 discloses a digital automated feeder for aquarium and pond animals. The digital feeder includes a digital system and display that allows users to enter parameters such as feed amounts and dates or tank conditions. However, the system delivers food by virtue of a screw drive in a food container. There is no dispenser for including selectable feedings corresponding to different days.

United States Patent Application Publication No. 20180242561 discloses a fish feeder comprising a food reservoir in a housing. A feeding track is actuated to control the flow of food from the feeding track at preselected times. The feeding track can provide only one type of food, namely the food in the reservoir. Discrete compartments each containing single feedings are not provided.

### SUMMARY

Briefly stated, in accordance with the present subject matter, an automated aquarium frozen fish food feeder is provided having a housing containing a cooling device and a dispensing device. The cooling device comprises a thermoelectric cooler. A preferred form of food comprises frozen cubes of a first dimension having fish food of a smaller size suspended therein. The frozen cubes are dispensed into a basket where they melt before being accessible to the fish. The melted fish food exits from the basket through openings of a size that prevent dispersal of the frozen cubes. The dispensing device is structured to minimize opportunities for heat to enter a cold chamber in which fish food is stored in order to maintain freshness of the food. The cooling device comprises one wall of the cold chamber. The dispensing device is constructed to open and dispense food and then close promptly in order to minimize heat exchange with ambient air. The dispensing device preferably comprises a carousel having a number of chambers to be filled with food. The carousel rotates and each food container periodically arrives at a feeding location in registration with a food outlet aperture which is closed at a bottom surface. A mechanism opens the bottom surface of the food container and dispenses food through the outlet aperture. The food is received by a perforated basket which allows the frozen food to melt in aquarium water before it is accessible to the fish. The carousel surface is preferably treated with a substantially friction-free coating. Preventing food from sticking to the container improves precision in the amount of food dispensed and minimizes contamination from old food. The carousel may be modular with respect to the feeder, and the carousel may be selectively removable from the feeder for cleaning or filling. A number of differently sized carousels may be provided each dedicated to a particular size of frozen food cubes, allowing user selection of the type of feeding to be provided. The carousel is included in a drawer below the cooling device for easy access for cleaning and for inserting selected carousels.

### BRIEF DESCRIPTION OF THE DRAWINGS

FIG. 1 is a perspective view of an automated frozen fish food feeder system including a home aquarium;

FIG. 2 is a front elevation of the feeder;

FIG. 3 is a cross sectional view of the feeder taken along line 3-3 of FIG. 2;

FIG. 4 is a perspective view of a cooling unit removed from the housing and mounted on a drawer;

FIG. 5 is a top isometric view of a feeder section on a base;

FIG. 6 is an enlarged view of the drawer showing a carousel in greater detail;

FIG. 7 is a perspective illustration of the drawer housing an alternative carousel;

FIG. 8 is a cross sectional view taken along line 8-8 of FIG. 5 illustrating engagement of the carousel in the drawer;

FIG. 9 is a partial isometric view of the carousel within the drawer illustrating interaction between the carousel in a first position and the chute;

FIG. 10 illustrates a door moved to a second, open position in which a chamber communicates with aperture and chute;

FIG. 11 is an isometric cross-sectional view of the drawer taken along line 11-11 of FIG. 6;

FIG. 12 is a bottom perspective view of the drawer illustrating positioning of a food catcher with respect to the drawer;

FIG. 13 is a block diagram of one form of a control unit;

FIG. 14 is a chart indicative of a nominal feeding program; and

FIG. 15 illustrates a dock system having an alternative method of melting frozen food before it becomes available to the fish.

### DETAILED DESCRIPTION

An automated aquarium frozen fish food feeder according to the present subject matter comprises a housing which positions a thermoelectric cooling device and a dispensing device in a juxtaposition to maximize heat exchange. The feeder is used to dispense frozen cubes of fish food. The frozen cubes are dispensed into a basket where they melt before being accessible to the fish. The dispensing device is structured to minimize heat exchange between a cold chamber and ambient air. The dispensing device preferably comprises a carousel having a number of chambers to be filled with food. The carousel rotates and each food container periodically arrives at a feeding location in registration with a food outlet aperture. The outlet aperture is kept closed when food is not being dispensed. The carousel surface is preferably treated with a substantially friction-free coating. The carousel may be modular with respect to the feeder. The carousel is included in a drawer below the cooling device for easy access for cleaning and for inserting selected carousels.

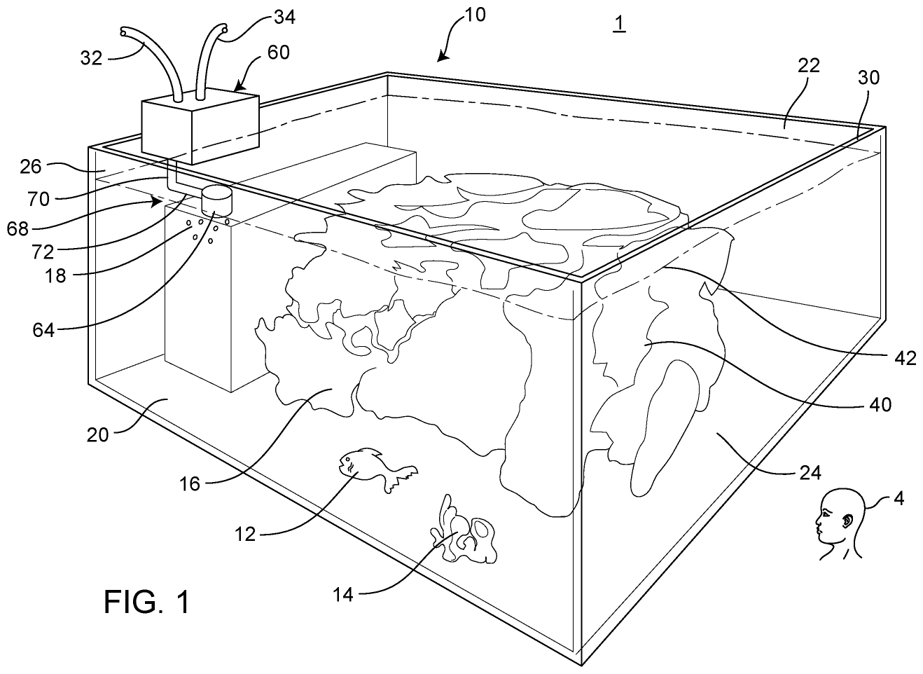

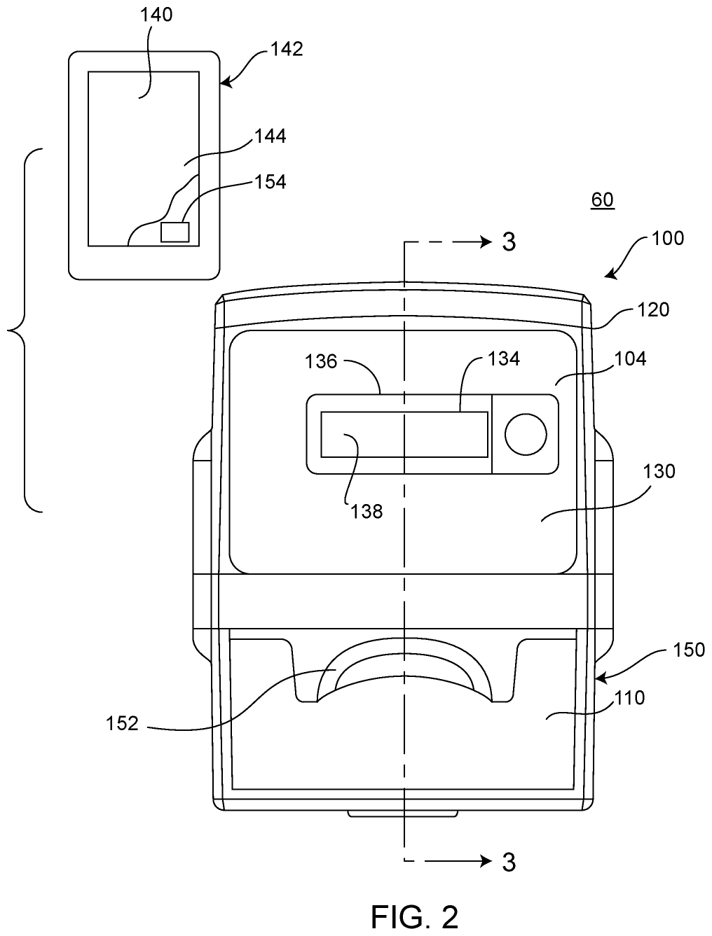

FIG. 1 is a perspective view of an automated frozen fish food feeder system including a home aquarium 1. A frozen fish food feeder 60 is provided to feed fish 12 kept in a tank 10. The tank 10 houses the fish 12 and decorative and useful articles 14 such as coral 16. The fish 12 may be freshwater fish or saltwater fish. Programming the feeder 60 is accomplished by an onboard microcontroller 154 (FIG. 2) and user interface allowing users to specify when the feeder 60 should feed. Additionally, the feeder 60 may be Wi-Fi enabled allowing the feeder 60 to send error messages, alerts, and notifications. The feeder 60 keeps the pre-frozen fish food in a frozen state. Thermoelectric cooling keeps the food frozen until dispensed in response to signals from a microprocessor controller. The control system may be onboard or remote. The user may program the feeder 60 via a separate Wi-Fi enabled device, e.g., using an app and a smart phone.

The tank 10 has a forward wall 20 in parallel with a rear wall 22. First lateral ends of the forward wall 20 and the rear wall 22 are joined by a first sidewall 24. Opposite lateral ends of the forward wall 20 and the rear wall 22 are joined by a second sidewall 26. In the present illustration, each of the walls 20 through 26 are of high strength transparent material such as tempered glass or lexan polycarbonate resin. Traditional aquarium constructions with metal frames could also be provided. The feeder 60 may be provided with mounting means that can cooperate with rimless walls, rimmed walls, or euro braced walls. A clamp mount 50 mounts the feeder 60 and is adaptable to all forms of tank rim. The clamp mount 50 is used for dispensing food 18 directly into the tank 10. Alternatively, the feeder 60 may be mounted on a base which is discrete from the tank 10. As a further alternative, a dock system 600 (FIG. 15) distributes food to the aquarium via a series of pumps. The dock system 600 allows a food source to be discretely placed out of view at the convenience of the user 4.

Euro bracing is provided by glass strips that run along the edge of the tank 10. These pieces of glass are at the top of the sides panes, at a right angle to provide additional strength. Euro braced walls comprise, for example, a substantially horizontal panel 30 having a transverse dimension extending from opposite walls. In the present example the opposite walls are the forward wall 20 and the rear wall 22. The panel 30 has a lateral width which is limited. Limits of the lateral width may be determined by the forces that will be applied to the forward and rear walls 20 and 22. Euro bracing may be provided extending along a top edge of the first side wall 24 extending from the forward wall 20 to the rear wall 22. Additionally, euro bracing may be provided at the top edge of each of the forward wall 20 and the rear wall 22 and extending between the first and second sidewalls 24 and 26.

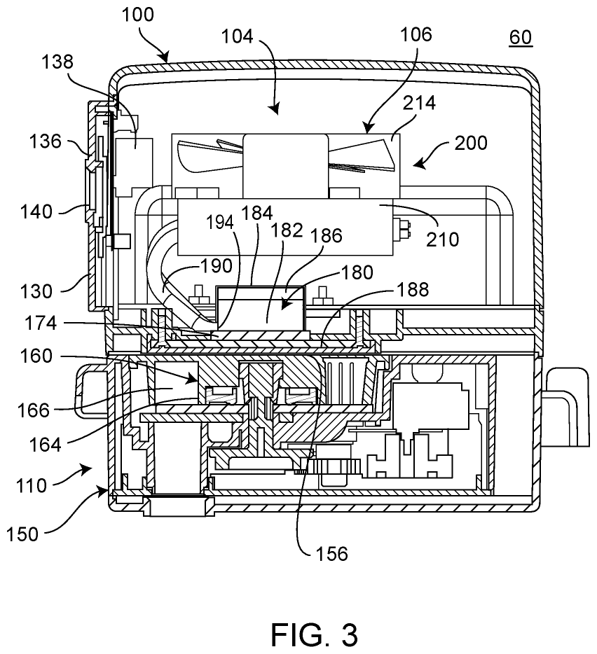

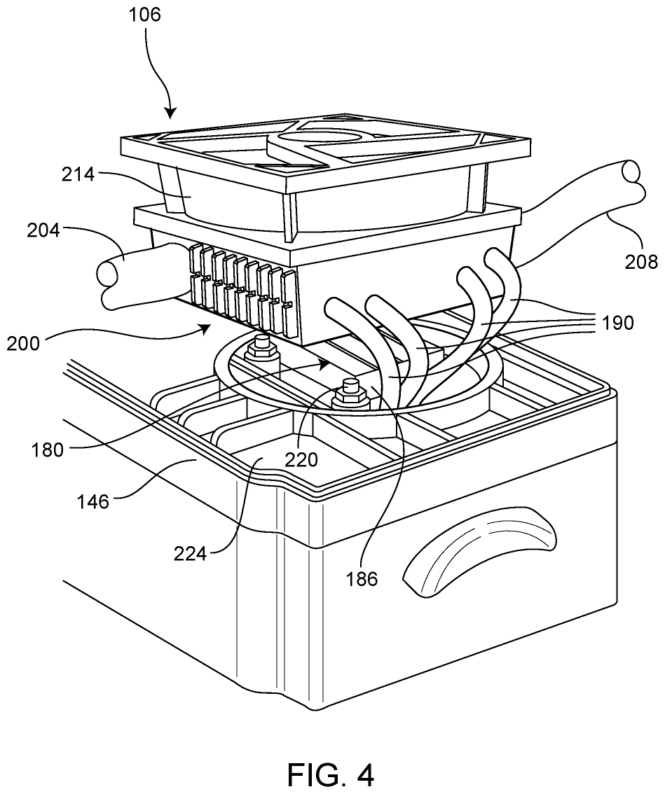

Air cooling or liquid cooling is used in dissipating heat from a thermoelectric cooling device (TEC) 180 (FIG. 3 and FIG. 4). In a liquid cooling embodiment, an input conduit 32 provides cooling water to the feeder 60. Water exits via the output conduit 34. This water flow provides liquid cooling for the heatsink module 210 (FIG. 4). Providing cooling water is an alternative to the air-cooled embodiment discussed with respect to FIG. 4 below.

The current subject matter comprises innovations in thermoelectric cooling not found in the prior art. The manner in which cold side temperature of the thermoelectric cooler is maintained provides greater efficiency and reliability in cooling. Operating this system 24/7, 365 days a year will cost an average user 4 about $80.00 a year at a nominal price per kilowatt hour at the time of filing this application. The automated frozen fish feeder system allows for loading up the feed tray (not shown in FIG. 1) and scheduling the aquarium 1's daily feed times. The feeder 60 has a feeder basket 64 supported to it in a spatial relationship so as to be positioned below the water line 42 when the feeder 60 is mounted above the water line 42 with respect to the tank 10 for operation. The user 4 can program the desired feeding schedule. The user 4 can provide up to five feeds per day or skip days altogether. By selecting the desired carousel, an appropriate number of cubed frozen fish food 18 or portions of cubed food 18 will be provided. The user 4 can link a dispenser to an existing aquarium controller (not shown in FIG. 1) to coordinate feeding modes, and to set notifications when its time to reload. It can also be programmed via a separate Wi-Fi enabled device.

The tank 10 holds a body of water 40. An upper surface of the body of water 40 defines a water line 42. The water line 42 is seen through the forward wall 20 as the interface between the water 40 and air. The feeder 60 comprises a frozen fish food dispenser. Frozen fish food 18 is dispensed from the feeder 60 to a feeder basket 64. The feeder basket 64 receives frozen food 18. The feeder basket 64 may conveniently comprise acrylic plastic, polyvinyl chloride (PVC), or polytetrafluoroethylene, often referred to by the trademark Teflon. The feeder basket 64 should be a non-stick material. Apertures 66 are formed in the feeder basket 64 to allow water flow. A mesh layer 74 lines the feeder basket 64. The feeder basket 64 confines frozen cubes 18 of a preselected size. When the cubed food 18 melts, particles of food that have thawed from the frozen fish food cube are released that are sufficiently small to exit through the mesh layer 74. Different gauge mesh may be selected in correspondence with the type of cubed food 18 being dispensed.

The feeder basket 64 is positioned below the water line 42. A support bracket 68 is releasably secured to the feeder 60. A vertical dimension of the support bracket 68 is selected so that the feeder 60 is disposed above the water line 42 and the feeder basket 64 is disposed below the water line 42. The support bracket 68 may conveniently be L-shaped, having a horizontal leg 70 and a vertical leg 72. The vertical leg 72 does not need to be of any particular length. However, the vertical leg 72 maintains the feeder basket in a spatial relationship with the feeder 60 so that it should be long enough to maintain the feeder basket 64 below the water line 42. The vertical leg 72 should keep the feeder basket 64 close enough to the surface of the water 40 so that frozen food 18 will fall vertically into the feeder basket 64. It is not desirable to expose the frozen food 18 to currents that may displace frozen food 18 from being in vertical registration with the feeder basket 64. Currents could be provided, for example, by a filter pump.

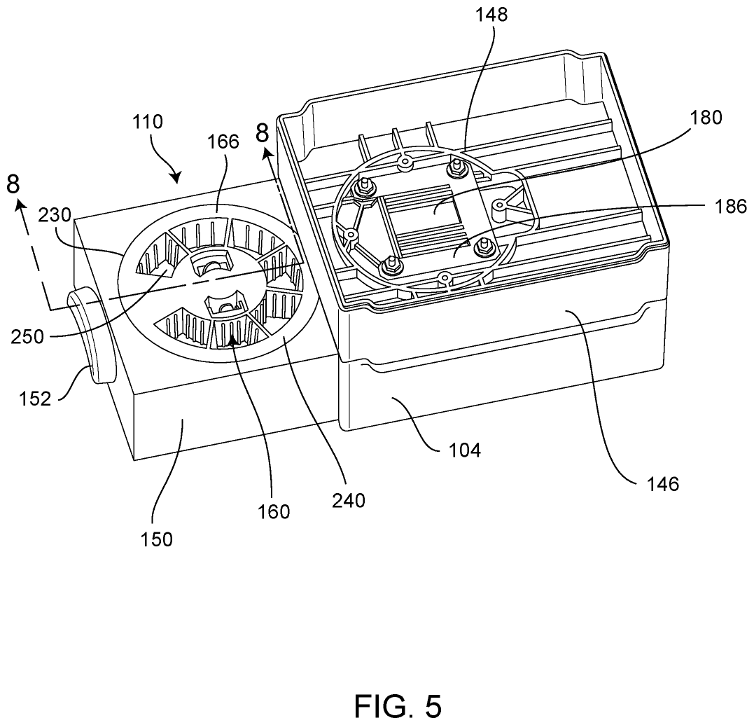

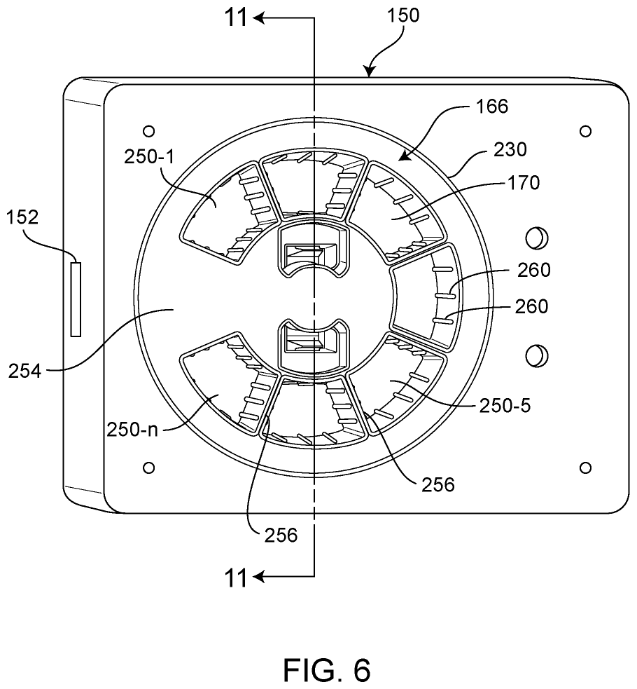

FIG. 2 is a front elevation of the feeder 60. The feeder 60 comprises a housing 100. The housing 100 which receives a cooler section 104 and a feeder section 110 in a frame 120. The feeder section 110 is a container that dispenses portions of food at predetermined intervals. The cooler section 104 has a front face 130. A control unit 138 is provided for informing a user 4 of operating parameters and allowing entry of settings to control operation. A user 4 may also select a feeding schedule and other parameters. The control unit 138 may comprise one or both of a graphical user interface (GUI) 140 and a remote module 142. The graphical user interface 140 may comprise a discrete module 134 mounted to be accessible through an aperture 134 in the front face 130. The control unit 138 is further described below. The graphical user interface (GUI) 140 is included in the remote module 142 and may comprise a touch screen 144. The touch screen 144 is partially broken away to reveal a microprocessor 154 in the remote module 142. The housing 100 may be constructed in a variety of sizes. Factors influencing the choice of sizes include the amount of space a user 4 may be expected to have in making room for both a tank and a feeder. Other factors include the size of a fish food dispenser, further described with respect to FIG. 5 and FIG. 6. Another factor is the size of heat exchange components further described with respect to FIG. 4. The control unit 138 contains menu software and integrates with apps.

The feeder section 110 may take the form of a drawer 150 which is modular with respect to the housing 100. The drawer 150 has a handle 152 with which a user 4 may slide or make movable the drawer 150 into or out of the feeder section 110. The front face 130 may have a selected color. The drawer 150 may have a color to match the color of the front face 130. Alternatively, the color of the drawer 150 may be selected to compliment the color of the front face 130. Multiple color options are available to match aquarium equipment. The food distribution structure in the present subject matter differs significantly from prior feeders which may include a sequence of compartments which are opened at a respective feeding time.

FIG. 3 is a cross sectional view of the feeder 60 taken along line 3-3 of FIG. 2. Each feeder section 110 comprises a cold chamber 160. Having the feeder section 110 modular with respect to the housing 100 provides a number of options. A plurality of feeder sections 110 may be provided. The cold chamber 160 is closed at a top by a base 146. The base 146 comprises an opening 156 which allows a distribution plate 188 to be open to the cold chamber 160. The cold side of the distribution plate 188, namely the side in the cold chamber 160 may be use specific materials, such as PTFE, also known by the registered trademark Teflon, or other coatings, stainless steel, or ceramic. A cold chamber fan 162 drives air flow in the cold chamber 160. The cold chamber fan 162 may be axial or a centrifugal blower. Directing air across the cold side increases heat exchange capability. The cold side requires the fan for air circulation within the cold chamber 160. As an alternative, the cold plate may be in direct contact with the food and properly coated to avoid icing, thus allowing for adequate cooling. The cold chamber 160 houses a food storage cartridge 164. In the feeder section 110, the cold chamber 160 has an open area at an upper side, which communicates with the opening 156 in the base 146. The base 146 is mounted to close the upper area with a distribution plate 188 in communication with the cold chamber 160. In one preferred form, the cold chamber 160 is circular.

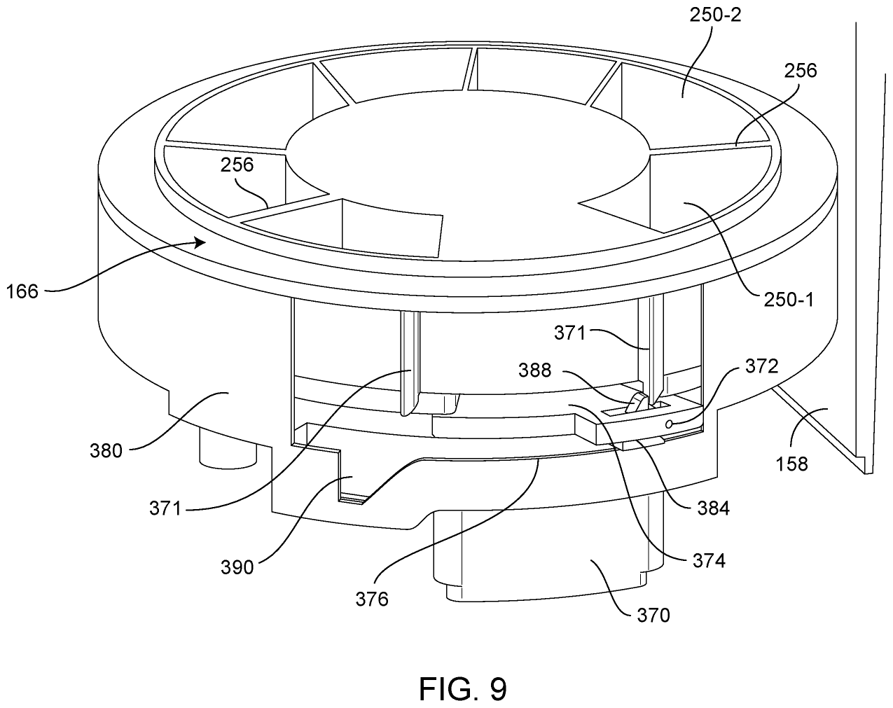

In one preferred form, the storage cartridge comprises a carousel 166. The carousel 166 may be preloaded with a set of fish food 18 of select types. The carousel 166 is housed in an annular wall 380 (FIG. 9). The carousels 166 may be kept in a freezer until ready to be used. One carousel 166 may be used to replace another in order to replace an empty carousel 166 with a full one or to replace one set of food with another. Additionally, the drawer 150 may have a preselected color for coordination with the front face 130 of the cooler section 104. The food cartridge 164 comprises the carousel 166. The carousel 166 is substantially circular and comprises a plurality of angularly displaced radially extending food chambers 250, each chamber 250 being open at a bottom. The cold chamber 160 has a support surface acting as a floor 170 for each chamber compartment. The cold chamber 160 has a dispensing opening. The outlet aperture 136, which is the dispensing opening, is formed in the floor 170.

The cooler section 104 comprises cooler 106 using a thermoelectric cooling device 180. The cooler 106 may comprise a thermoelectric freezer. The thermoelectric cooling device 180 will commonly comprise a 12 volt first Peltier effect device 182. In order to keep fish food 18 frozen until it is ready for distribution, the feeder 60 utilizes a thermoelectric cooler 180. The hot side of this is kept cool with an oversized heatsink 210 equipped with heat pipes 190 and a fan 214. The cold side utilizes a cold plate 174 to keep the cold chamber 160 below 0° C. The first Peltier effect device 182 is mounted to a distribution plate 188. The first Peltier effect device 182 comprises a junction of two different conductors of electricity. An electric current applied to the junction creates a heat flux and lowers temperature. A plurality of first Peltier effect devices 182 laterally displaced from one another may be used in series to increase the amount of cooling. In one preferred form, each TEC 180 is sealed in a coating 184. The TEC 180 needs to be sealed against moisture. Suitable materials for the coating 184 include silicon RTV, resin, and epoxy. The coating 184 eliminates or reduces condensation and prevents minimizes frost buildup. In a further form, a second Peltier effect device 186 is placed on top of the first Peltier effect device 182. This stacked TEC arrangement provides for a lower temperature. Use of the two Peltier effect devices changes the temperature versus voltage curve and may be used for faster cooling.

In one preferred form, the distribution plate 188 is positioned in the cooling section 104 to cooperate with the feeder section 110 in order to close the cold chamber 160, positioned above and cooperating with the cold chamber 160. Heat pipes 190 conduct heat from the thermoelectric cooling device 180 to a heat exchange unit 200. Use of thermoelectric cooling allows for a compact 3.5″×4″ square form factor. Other sizes of thermoelectric coolers 180 may be utilized. The heat exchange unit 200 comprises a heat sink module 210. The heat pipes 190 extend into the heat sink module 210, which is cooled by a fan 214. The thermoelectric cooler (TEC) 180 cooperates with the carousel 166 to keep the cold chamber 160 below 0° C. On a hot side of the TEC 180, there is a large heatsink 210 to maintain operation and prevent failure of the TEC 180. “Large” refers to a size greater than normally specified in a manufacturer's data sheet for a respective component. On a cold side is a cold distribution plate 188 to keep the frozen food 18 below 0° C. A motor 360 (FIG. 9) is used to rotate a carousel 166 in order to dispense frozen fish food 18 at user determined intervals. These intervals are programmed via microcontroller 154 (FIG. 2) and a user interface.

Each heat pipe 190 is a heat transfer device that uses evaporation and condensation of a two-phase working fluid, or coolant, to transport large quantities of heat with a small difference in temperature between hot and cold surfaces. Since the cooling section 104 is a freezer, methanol is used as the working fluid rather than water. The heat pipes 190 each comprise a thermoconductive metal tube, preferably copper, and a wick to return working fluid from an evaporator 194 to a condenser 196. The evaporator 194 is an end of the heat pipe 190 at the distribution plate 188. This is where heat is removed from the cooler section 104. The working fluid evaporates to vapor and absorbs thermal energy. The condenser is an end of the heat pipe 190 at the heat exchange 200. The working fluid condenses and flows back to the evaporator 194.

FIG. 4 is a perspective view of the cooling unit 106 removed from the housing 100 and mounted on the drawer 150. The cooler section 104 has a base 146. The base 146 covers the feeder section 110. The base 146 comprises a circular wall 148 in registration with the cold chamber 160. The cold chamber 160 comprises a heat transfer opening. An opening 156 is located within the boundary of a circular wall 148 so that the thermoelectric cooling device 180 communicates with the cold chamber 160. The circular wall 148 contains a section from which the fasteners 220 extend. The distribution plate 188 closes the cold chamber 160. The distribution plate 188 is bolted by fasteners 220 to the base 224 of the cooler section 146. The thermoelectric cooling device 180 is seen atop the distribution plate 188. The first pair of heat pipes 190 and a second pair of heat pipes 192 each have a first end at the thermoelectric cooling device 180. Working fluid carries heat from the first end to a second end at the heat exchange unit 200. The TEC can be actively cooled using an air cooled or liquid cooled heatsink.

The heat exchange unit 200 comprises cooling fins 204 of a heatsink 212. In an air cooled embodiment a fan 214 is mounted to remove heat from the heat exchange unit 200. Preferably a neutral airflow is used in which the pressure inside the heat exchange unit 200 is substantially equal to the pressure outside the heat exchange unit 200. The high efficiency liquid cooling apparatus operates silently. The primary source of sound is the fan 214. Proper selection of the fan 214 will provide a cooling unit that runs more quietly than other subsystems in an aquarium.

FIG. 5 is a top isometric view of the feeder section 110 and the base 146. In the illustration of FIG. 5, the drawer 150 is slid out from the cooler section 104. The mounting base 146 is illustrated with the heat exchange unit 200 and fan 214 removed from the cooler section 104. The mounting base 146 mounts the heat exchange plate to close the heat transfer opening of the cold chamber 160. The thermoelectric cooler 180 and distribution plate 188 are illustrated within the confines of the circular wall 148. The distribution plate 188 comprises a heat exchange plate. Portions of the heat exchange unit 200 and the fan 214 are supported above the circular wall 148. The remainder of the heat exchange unit 200 and the fan 214 are supported in registration with the portion of the base 146 which is outside of the circular wall 148. The drawer 150 is in its “slid out” position. In this position the carousel 166 is accessible for loading frozen fish food 18.

FIG. 6 is an enlarged view of the drawer 150 showing the carousel 166 in greater detail. The cold chamber 160 comprises a cylindrical recess 230 having a floor 170 which receives the carousel 166. The carousel 166 comprises a plurality of radial chambers 250, numbered 250-1 through 250-n, where n is an integer. In one preferred form n=7. When n=7, one chamber 250 may be used to correspond to one day of the week. Additionally, there is an eighth radial location comprising a covered radial chamber 254. Walls 256 are intermediate adjacent chambers 250. When the carousel 166 is in an initial angular position, the covered radial chamber 254 is in registration with the outlet aperture 136. The total number of chambers in the carousel 166 is n+1. In the present illustration, n+1=8. Therefore, each chamber 250 or 254 will subtend an arc of 360°/8, or 45°. When it is desired to feed the fish once a day, the carousel is rotated 45° once a day.

The user 4 may select their desired carousel 166 to provide a respective size serving of frozen fish food. A nominal range of carousel sizes will accommodate seven full size cubes, fourteen half size cubes, or up to twenty-one quarter cubes. A user 4 may keep a plurality of carousels 166, each loaded with a different size cube of frozen fish food. The carousels 166 are interchangeable.

Nonstick surfaces are provided to minimize friction and to minimize any tendency of fish food to stick to the walls 256. A common nonstick coating is polytetrafluoroethylene (PTFE), often referred to by the trademark Teflon®. The PTFE coating is safe at temperatures below 32° F. PTFE does not begin producing toxic emissions below 500° F. To further aid in preventing sticking of fish food, each of the chambers 250, outer circumferential surfaces 280, inner circumferential surfaces 284, and the walls 256 are provided with vertical ribs, which are referred to as nubs 260. These nubs 260 are coated to prevent sticking. The non-stick coating provides for greater precision in food dispensing. The non-stick coating also minimizes retention of food in the carousel 166 that can harbor bacteria.

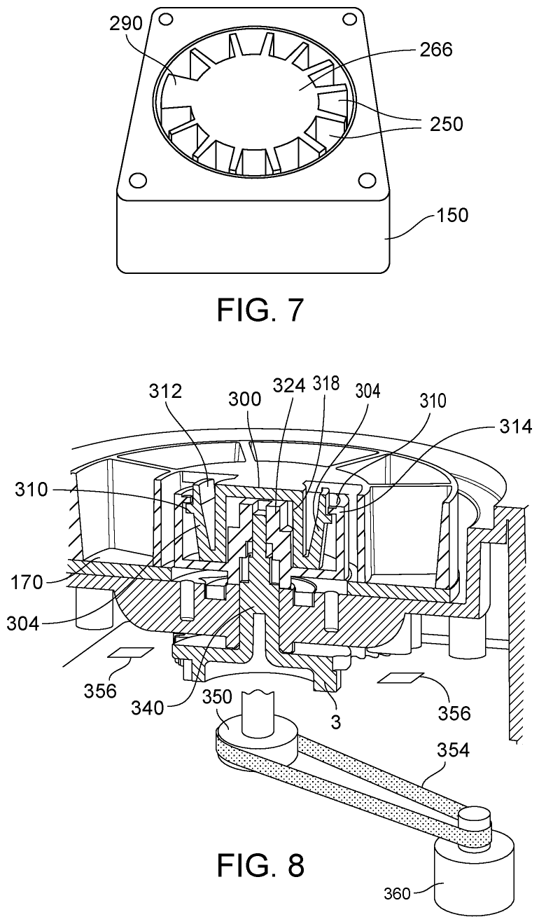

FIG. 7 is a perspective illustration of the drawer 150 housing a second carousel 266. The carousel 266 is an alternate embodiment of the carousel 166. The carousel 266 has a larger number of chambers 250 than the carousel 166. This structure provides for a greater number of feedings in one revolution of the carousel 266. In the carousel 266, n=13, and there is one covered chamber 290. Where daily feedings are provided, the carousel 266 can provide just short of two weeks worth of feeding. In addition to providing a different number of feedings, the carousel 266 may be loaded with a different type of frozen fish food 18 and stored in a freezer. The user 4 has the option of removing the carousel 166 or 266 and replacing it with the other. The carousel 266 offers options to a user 4 who may be absent for a longer period of time.

FIG. 8 is a cross sectional view taken along line 8-8 of FIG. 5. FIG. 8 illustrates engagement of the carousel 166 in the drawer 150. The carousel 166 comprises a central hub 300. The central hub 300 comprises a deformable concentric flange 304 having a detent 310 and a tab 312. The detent 310 bears against a radially inwardly projecting stop 314 on an annular hub wall 318 supported to and concentric with an inner drive hub 324 projecting into the cold chamber 160. The carousel 166 may be released from the drawer 150 by squeezing the tabs 312 toward each other. The detent 310 then no longer bears against the inwardly projecting stop 314 and may be lifted out of the drawer 150. The inner drive hub 324 is keyed to be releasably secured to a drive shaft 340. The drive shaft 340 comprises an axial projection from a drive gear 350. The drive gear 350 is coupled to a source of motive power such as a stepper motor 360 and positioned for driving the food cartridge to a preselected angular position. The control unit 138 commands motion of the drive mechanism. The preselected angular position is generally in registration with the outlet aperture 136. The drive gear 350 and the stepper motor 360 are included in a drive mechanism 364. The drive mechanism 364 is coupled to place the food cartridge in successive positions, in order to place one food chamber in registration with the dispensing opening. Utilizing a stepper motor 360, belt drive 354, gears and position sensors 356, the carousel 166 is moved to precise positions in order to bring each chamber 250 sequentially in engagement with the chute 370 (FIG. 9) to distribute food. The belt drive 354 transfers circumferential force from the stepper motor 360 to the drive gear 350. A movable door 374 (FIG. 9) is utilized to maintain the efficiency keeping the cold chamber as cool as possible. The door 374 keeps the cold chamber 160 closed until food is to be dispensed. The carousel 166 is removable for maintenance and to swap out sizing and spacing for higher quantities of smaller cubes of fish food 18. The carousel 166 utilizes vertically extending nubs 260 to prevent sticking of frozen fish food 18 along with a slick material on the cold chamber floor 170 to minimize sticking. The cold chamber 160 is removable from the feeder 60 via the pull out drawer 150 for maintenance and reloading purposes.

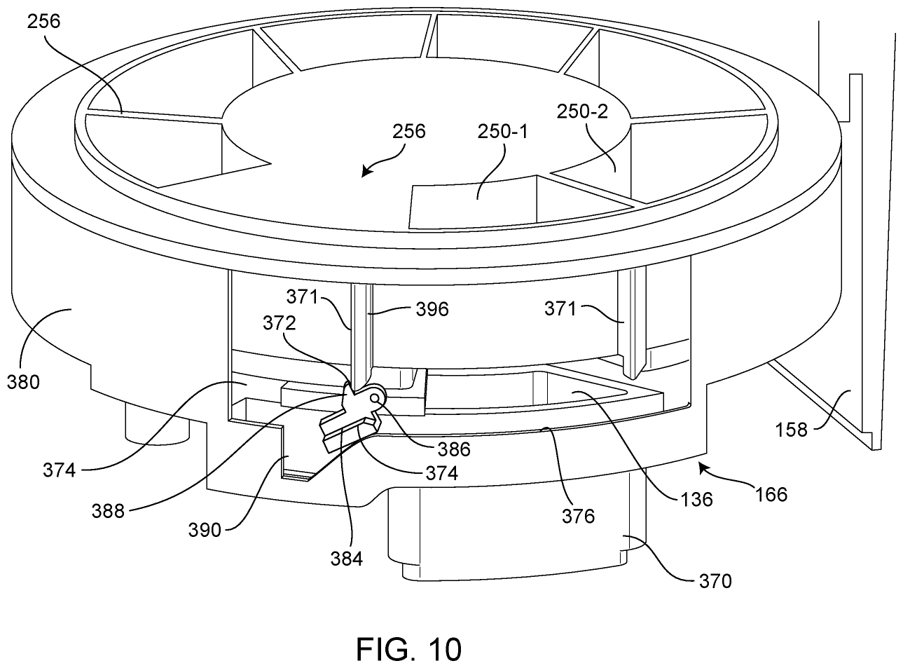

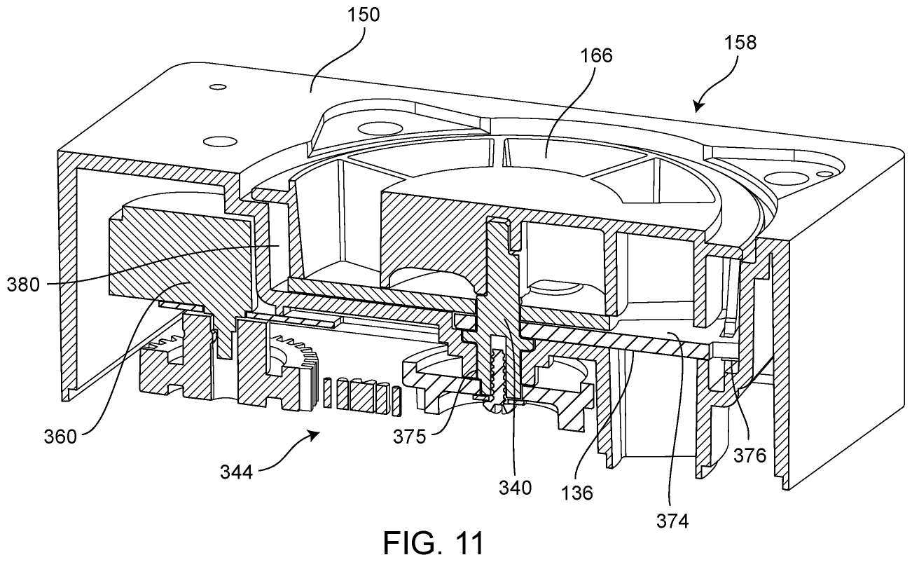

FIG. 9 and FIG. 10 are each a partial isometric view of the carousel 166 within the drawer 150 (FIG. 11) illustrating interaction between the carousel 166 and the chute 370 through which fish food 18 is dispensed. The chute 370 directs frozen fish food cubes toward the feeder basket 64 (FIG. 1). In FIG. 9 a door 374 covers the aperture 136 in the cold chamber floor 170 to keep the cold chamber 160 closed. FIG. 10 illustrates the door 374 moved to a second, open position in which a chamber 250-1 communicates with aperture 136 and chute 370. FIG. 11 is an isometric cross-sectional view of the drawer 150 taken along line 11-11 of FIG. 6. FIG. 9, FIG. 10, and FIG. 11 are taken together.

In order to feed fish, the carousel 166 is driven by a driver such as a motor 360 (FIG. 8). The motor 360 preferably comprises a stepper motor to interact with a digital control unit 138 (FIG. 2) further described below. In the present illustration, motive power is transmitted to the drive shaft 340 via transmission gears 344. In a first angular position of the carousel 166, the door 374 closes the aperture 136. The carousel 166 has n+1 vertically disposed radial projections 396. In the present illustration n+1=8. As the carousel 166 rotates and a compartment 250 comes into registration with the aperture 136, a lower end of the vertical wall 396 engages the cam 388 on the pivoted lever 384.

When a chamber 250 is brought into angular registration with the aperture 136, frozen fish food 18 drops through the aperture 136 and proceeds through the chute 370. The carousel comprises an axial projection 371 to engage the door 374 and move the door 374 angularly to the first, open position as a food chamber 250 comes into registration with the outlet aperture 136. The axial projection 371 releases engagement with the door 374 when the carousel 166 arrives at a next position and a biasing source 375, such as a spring, closes the door 374. Preferably, the angular displacement of the carousel 166 is selected to have an “over travel” commanded position. More specifically, the forward wall, in the direction of angular travel, is placed at a preselected number of degrees beyond a side of the aperture 136. This preselected number of degrees is less than the number of degrees subtended by a wall 256. In this manner, the cavity 250-2 is not exposed. When the edge of the chamber 250 reaches its over travel position the door 374 snaps back to the closed position.

The fish food 18 may drop into the food container 62 (FIG. 1). An annular wall 380 has a circumferential opening extending from each side of the chute 370. A pivoted lever 384 is mounted to a radial outward circumferential surface of the door 374. A lower end of the axial projection 371 engages a lever cam 388 on the pivoted lever 384 and moves the door 374 angularly to the open position as a food chamber 250 comes into registration with the outlet aperture 136. The axial projection 371 pushes the pivoted lever 384 into a recess 390. The axial projection 371 cams the lever cam 388 and slides over it. The pivoted lever 384 no longer restrains the door 374, and the biasing source 375 closes the door 374. The pivoted lever 384 comprises a slide 372. As the axial projection 371 pushes the cam 388, the slide 372 slides along an axially disposed guide surface 376. The axially disposed surface 386 is on a lower edge of the opening in the annular wall 380.

The door 374 pivots on the drive shaft 340 and is spring-loaded or otherwise biased toward the closed position. The slide 372 rides along the guide surface 376, keeping the cam 388 vertical and engaged with the carousel 166. As the door 374 and slide 372 reach the end of the guide surface 376, the slide 372 slides into the recess 390, and the door 374 closes. The forward edge of the chamber 250-1 is moved to a position beyond the edge of the aperture 136. This angular displacement in one form is an over travel of 9°. This over travel does not expose a leading edge of the next cavity 250. This ensures the slide 372 is released allowing the door 374 to snap back.

The control unit 138 (FIG. 2) will command the next movement of the carousel 166 at the next time that has been programmed. In a next operation, the carousel 166 will rotate and bring the next chamber 250 into alignment with the chute 370.

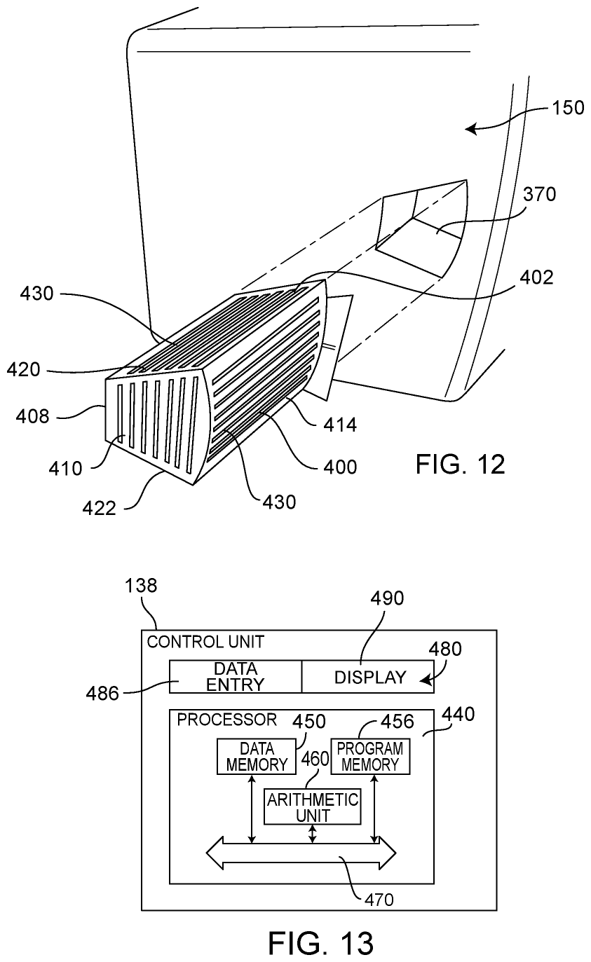

A further form of food container 62, namely a food catcher 400, is illustrated in FIG. 12. FIG. 12 is a bottom perspective view of the drawer 150. The food catcher clicks on to an underside of the drawer 150 and has a chamber with an open end 402 which will be located to surround the outlet of the chute 370. The horizontal cross-section of the catcher 400 may be a sector. The sector is truncated to have a planar inner surface 408. A lower surface 410 is substantially parallel to the open end 402. An outside radial wall 414 may be concentric with the carousel 166. A first radial wall 420 and a second radial wall 422 close sides of the catcher 400. Feeder apertures 430 are provided in the catcher 400. This construction will allow frozen food to melt before it is accessible to the fish 12. The apertures 430 preferably comprise vertical slots. Fish food is commonly provided in the form of frozen cubes. The feeder apertures 430 are selected to be small enough to confine the frozen cubes. The frozen cubes are placed into the chambers 250. When the chamber 250 comes into the feeding position, namely in registration with the chute 370, the frozen cubes enter the water 40. The cubes melt, and food particles are released into the water 40. The apertures 430 are selected to be large enough to permit passage of food. In this manner, food can be dispensed to fish in normal, thawed form while the food can be stored as frozen cubes.

FIG. 13 is a block diagram of one form of the control unit 138 (FIG. 2). The control unit is enabled to provide motive power at preselected times by energizing the stepper motor 360 in the drive mechanism 364. The heart of the control unit 138 is a processor 440. The processor 440 includes data memory 450, a program memory 456, and arithmetic unit 460. The key communication between the memories 450 and 456 and the arithmetic unit 460 as well as communications outside of the control unit 138 are provided via a data bus 470. Additionally, a graphical user interface (GUI) 480 is provided. The GUI 480 includes a data entry pad 486 and a display 490. The data entry pad 486 could comprise a keyboard or touch screen or other means of data entry such as voice control. The display 490 may comprise a touch screen and will normally comprise an LED color display. The program memory 456 may operate the GUI 480 to provide simplified scheduling and provide alerts to users 4 as to when they need to reload.

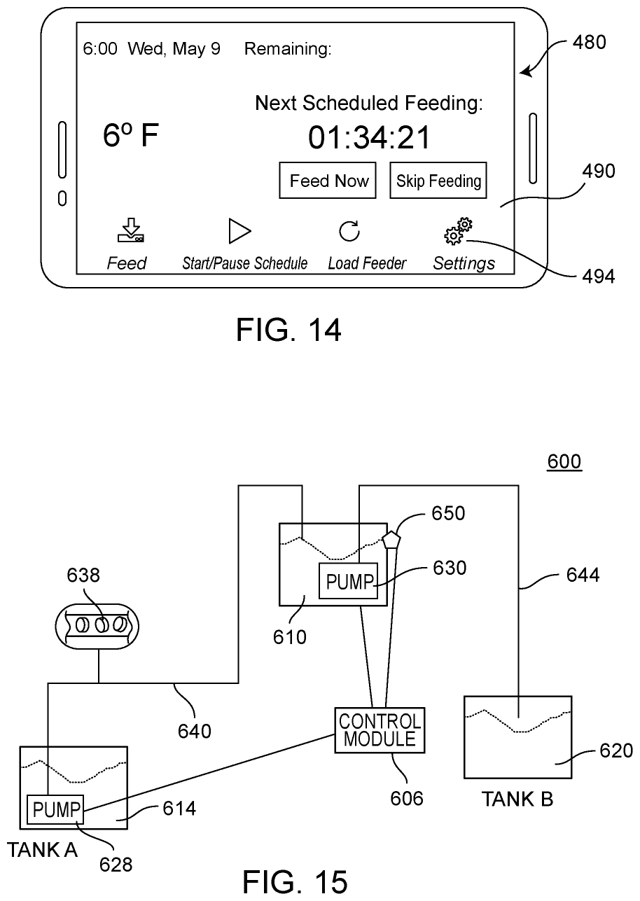

FIG. 14 illustrates a nominal graphical user interface (GUI) 480. A touch screen 490 may conveniently comprise an LED display. Other forms of display may be utilized. Many parameters may be controlled. A typical display may include time and date, number of feedings executed and remaining for a currently installed carousel 166, temperature of the cold chamber 160 either in Fahrenheit or Centigrade, time of next feeding, and command buttons to initiate or cancel a feeding. A settings button 494 may be provided to bring up a menu through which a user 4 may command feeding parameters and communication paths. These may include frequency of feeding and current status. The control unit 138 may also be coupled to other devices such as a thermostat, pH meter, and aerator to command smooth functioning of the aquarium and to provide status to a user 4. The control unit 138 need not be a discrete component. Existing controllers having a 1v-10v output can trigger the feed command. Therefore, the control unit 138 can be integrated with most aquarium controllers on the market.

FIG. 15 illustrates a dock system 600 having an alternative method of melting frozen food before it becomes available to the fish 12. The dock system 600 is controlled by a control module 606. This alternative embodiment has the carousel replaced by two pumps and the food could be a slurry 638 that does not freeze water which carries frozen food. When activated a small, metered dose of the slurry 638 could be distributed into a chamber by a first pump 628. A second pump 630 would then pump aquarium water through the chamber until it was clear. This dock system comprises a dock tank 610, a first tank 614 and a second tank 620. The first pump 628 is in the first tank 614. The second pump 630 is in the dock tank 610. A water conduit 640 moves slurry 638 from the pump 628 in the first tank 614 to the dock tank 610. A second conduit 644 provides a path for water from the second pump 630 to the second tank 620. An optical sensor 650 measures water level in the dock tank 610. This optical sensor 650 provides a level signal to the control module 606. In response to the level signal the control module 606 produces a signal to turn off the pump 628. A delay is provided before the second pump 630 is turned on. The delay allows food to thaw. A nominal delay is five minutes. The second pump 630 then pumps food into the second tank 620. A cycle may be provided to flush the conduit 644. Water is pumped in to the second tank 620 a plurality of times. In one preferred embodiment three cycles are provided to flush the conduit 644.

In a further embodiment only the first tank 614 is provided. Slurry 638 can be pumped from the first tank 614 to the dock tank 610. Thawed food may then be pumped back from the dock tank 610 to the first tank 614.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. An aquarium feeder for dispensing frozen aquarium food comprising:
a. a cooler section comprising a thermoelectric cooling device;
b. a base supporting said thermoelectric cooling device;
c. a distribution plate thermally connected to said thermoelectric cooling device;
d. a feeder section including a cold chamber having an open area at an upper side thereof, said base being mounted to close said upper area with said distribution layer in communication with said cold chamber;
e. said cold chamber being shaped to receive a storage cartridge and having a floor and an outlet aperture through which fish food may fall when a cartridge is placed in the cold chamber and moved to a position such that the cartridge has a food chamber in registration with said outlet aperture; and
a drive mechanism mechanically coupled to a source of motive power and positioned for driving the food cartridge to a preselected position.

2. The aquarium feeder according to claim 1 wherein said cold chamber is circular and further comprising the food cartridge, said food cartridge being substantially circular and comprising angularly displaced radially extending food chambers, each chamber being open at a bottom thereof, said cold chamber having a support surface acting as a floor for each said compartment and wherein said outlet aperture is formed in said floor.

3. The aquarium feeder according to claim 2 further comprising a control unit for enabling motive power at a preselected time to rotate the food cartridge to place a next food chamber in registration with said outlet aperture.

4. The aquarium feeder according to claim 3 further comprising a feeder basket supported to said feeder in a spatial relationship with said aquarium feeder so as to be positioned below an aquarium water line when said aquarium feeder is fixed in an operating position above the aquarium water line and positioned in vertical registration with said outlet aperture.

5. The aquarium feeder according to claim 4 wherein said feeder basket has apertures to permit waterflow and to confine frozen fish food cubes of a preselected size.

6. The aquarium feeder according to claim 5 wherein said feeder basket comprises a mesh layer having openings of a size to permit passage of frozen fish food after thawing from a frozen fish food cube.

7. The aquarium feeder according to claim 6 further comprising a chute in registration with said outlet aperture positioned to direct frozen fish food cubes toward said feeder basket.

8. The aquarium feeder according to claim 3 wherein said cold chamber further comprises a movable door closing said outlet aperture in a first position and opening said aperture outlet in a second position, said carousel comprises a projection to engage said door and move said door angularly to the open position as a food chamber comes into registration with the outlet aperture, said projection releasing engagement with said door when said carousel arrives at a next position and a biasing source to close the door.

9. The aquarium feeder according to claim 2 wherein said feeder section and said cooler section are mounted in a housing and wherein the feeder section is included in a drawer mounted to be movable with respect to the frame in order to expose said cold chamber.

10. An aquarium feeder for dispensing frozen aquarium food comprising:
a. a thermoelectric freezer having a heat exchange plate;
b. a food dispenser comprising a cold chamber, the cold chamber having a heat transfer opening and having a dispensing opening;
c. a mounting base mounting the heat exchange plate to close the heat transfer opening of said cold chamber;
d. a food storage cartridge received in said cold chamber, said food storage cartridge having a plurality of food chambers;
e. a drive mechanism coupled to place said food cartridge in successive positions, in order to place one food chamber in registration with the dispensing opening; and
f. said cold chamber being shaped to receive a food cartridge and having a floor and an outlet aperture through which fish food may fall when a cartridge is placed in the cold chamber and moved to a position such that the cartridge has a food chamber in registration with said outlet aperture.

11. The aquarium feeder according to claim 10 wherein said thermoelectric freezer comprises a first thermoelectric cooling device and a second thermoelectric cooling device being stacked on said first thermoelectric cooling device, said first thermoelectric cooling device contacting the heat exchange plate.

12. The aquarium feeder according to claim 10 further comprising a feeder basket positionable below a water line and having apertures to confine frozen fish food cubes and apertures permitting passage of fish food thawed from the frozen fish food cubes, and further comprising a door in registration with the outlet aperture positionable to open said cold chamber at the outlet aperture in a first position and to close said cold chamber in a second position.

13. The aquarium feeder according to claim 12 wherein said food storage cartridge comprises a modular, rotatable carousel having angularly displaced radially extending chambers, each chamber being open at upper and lower ends thereof, and having an angular width substantially equal to the angular width of said outlet aperture.

14. The aquarium feeder according to claim 13 wherein an inner drive hub projects into said cold chamber and wherein said carousel comprises a central hub received on said inner drive hub.

15. The aquarium feeder according to claim 14 wherein a drive shaft is releasably secured to said inner drive hub, the drive shaft comprising an axial projection from a drive gear, a drive mechanism coupled to be positioned for driving the food cartridge to a preselected angular position and a control unit commanding motion of said drive mechanism.

16. The aquarium feeder according to claim 13 wherein said feeder section is movable with respect to said cooler section to permit access to said cold chamber.

17. A method for dispensing frozen aquarium food from an aquarium feeder comprising:
a. providing a feeder section comprising a cold chamber and a food cartridge received in the cold chamber, the food cartridge comprising a plurality of food chambers;
b. placing frozen fish food in selected food chambers;
c. maintaining the frozen state of the frozen fish food utilizing thermoelectric cooling;
d. moving a food chamber to a feeding position in registration with a dispensing aperture;
e. opening a door to open a path between the food chamber and aquarium water; and
f. letting the food fall into aquarium water and confining the food prior to thawing.

18. The method according to claim 17 wherein the step of opening a door comprises engaging the door with the food cartridge to move the door in an angular direction against biasing force.

19. The method according to claim 18 wherein the step of opening a door further comprises disengaging the food cartridge from the door when the food chamber reaches a feeding position to allow the biasing force to close the door.

20. The method according to claim 19 wherein the step of confining the food prior to thawing comprises directing frozen aquarium food to a container which confines frozen food cubes and allowing thawed food to exit from the container.
